(19) United States
(12) Patent Application Publication
(10) Pub. No.: US 2013/0149400 A1
(43) Pub. Date: Jun. 13, 2013

(54) Cobweb Inhibitor and Spider Repellent

(71) Applicant: Nisus Corporation, Rockford, TN (US)

(72) Inventors: Jeffrey D. Lloyd, Knoxville, TN (US); Ronald T. Schwalb, Knoxville, TN (US)

(73) Assignee: Nisus Corporation, Rockford, TN (US)

(21) Appl. No.: 13/693,452

(22) Filed: Dec. 4, 2012

Related U.S. Application Data
(60) Provisional application No. 61/569,233, filed on Dec. 10, 2011.

(51) Int. Cl. A01N 65/44

(52) U.S. Cl. CPC A01N 65/44
USPC 424/750

(57) ABSTRACT

A composition which is fatal and repellant to pests such as spiders, insect, and mold is disclosed. In concentrate form, the composition includes from about 1 to about 50 percent, by weight, of at least one surfactant; from about 1 to about 50 percent, by weight, of at least one essential oil; optionally, from about 2 to about 50 percent, by weight, of at least one carboxylic acid having from 1 to 6 carbon atoms and optionally from about 5 to about 50 percent, by weight, of at least one alcohol having from 1 to 6 carbon atoms, wherein all percentages are based on the concentrate in undiluted form. The concentrate may also be diluted with a solvent prior to use.

### CROSS REFERENCE TO RELATED APPLICATIONS

This application claims the benefit of U.S. Provisional Application No. 61/569,233, filed Dec. 10, 2011.

### FIELD

The present disclosure relates to the field of pest control, and more particularly to a composition and method for killing and/or repelling fungi, insects and arachnids, as well as removing cobwebs and inhibiting cobweb formation.

### BACKGROUND

Fungi, insects and arachnids (such as spider) are undesired pests and nuisances commonly found in and around residential homes, commercial buildings, barns, storage sheds, and various other structures. Not only are spiders an undesired pest in and of themselves, spiders also construct unsightly spider webs, which are sometimes referred to as cobwebs. Even if the spiders themselves are removed, their leftover cobwebs must still be removed as well.

Accordingly, there is a need for treatment for homes and other buildings which can help remove cobwebs and is fungicidal, insecticidal and repellant to spiders or web adhesion and which, by repelling spiders, will also help remove and inhibit the production of cobwebs.

### SUMMARY

In a first aspect, the present disclosure provides a pest control concentrate composition. In one embodiment, the concentrate composition includes from about 1 to about 50 percent, by weight, of at least one surfactant; and from about 1 to about 50 percent, by weight, of at least one essential oil, wherein all percentages are based on the concentrate in undiluted form. Optionally, the concentrate composition may also include from about 2 to about 50 percent, by weight, of at least one carboxylic acid having from 1 to 6 carbon atoms and from about 5 to about 50 percent, by weight, of at least one alcohol having from 1 to 6 carbon atoms.

In certain embodiments, the at least one carboxylic acid preferably includes acetic acid.

In some embodiments, the at least one surfactant preferably includes an anionic surfactant. More preferably, the at least one surfactant includes sodium lauryl sulfate.

In some embodiments, the at least one alcohol preferably includes isopropyl alcohol.

In at least one embodiment, the at least one essential oil includes an oil selected from the group consisting of thyme oil (preferably of the chemotype linalool), lemon grass oil, citronella oil, lavender oil, phenethyl propionate, and combinations thereof.

In a second aspect, the present disclosure provides a diluted pest control composition. In one embodiment, the diluted composition includes from about 5 to about 50 percent, by weight, of the aforementioned concentrate composition and from about 50 to about 95 percent, by weight, of a solvent.

In a preferred embodiment, the diluted pest control composition includes a solvent; from about 1 to about 20 percent, by weight, of at least one carboxylic acid having from 1 to 6 carbon atoms from about 0.5 to about 12 percent, by weight, of at least one surfactant; from about 0.5 to about 8 percent, by weight, of at least one essential oil; and optionally, from about 2 to about 20 percent, by weight, of at least one alcohol having from 1 to 6 carbon atoms, wherein all percentages are based on the composition in diluted form.

In a particularly preferred embodiment, the diluted pest control composition includes from about 70 to about 85 percent, by weight, water; from about 4 to about 6 percent, by weight, acetic acid; from about 3.5 to about 5.5 percent, by weight, sodium lauryl sulfate; from about 5 to about 10 percent, by weight, isopropyl alcohol; and from about 1 to about 10 percent, by weight, essential oils, wherein all percentages are based on the composition in diluted form.

Most preferably, the essential oils include from about 1 to about 3 percent, by weight, thyme oil (chemotype linalool), about 1 to about 3 percent, by weight, lemongrass oil, and about 1 to about 3 percent, by weight, citronella oil, based on the overall composition, wherein all percentages are based on the composition in diluted form.

In some embodiments, the diluted pest control composition includes from about 50 to about 60 percent, by weight, water; from about 6 to about 8 percent, by weight, acetic acid; from about 10 to about 15 percent, by weight, sodium lauryl sulfate; from about 50 to about 10 percent, by weight, isopropyl alcohol; and from about 1 to about 10 percent, by weight, essential oils, wherein all percentages are based on the composition in diluted form.

In other embodiments, the diluted pest control composition includes from about 1 to about 3 percent linalool. In another embodiment, the pest control composition further includes from about 1 to about 7 percent, by weight, of an emulsifier. In yet another embodiment, the emulsifier is decyl alcohol.

In still another aspect, the present disclosure provides a method for controlling household pests. In one embodiment, the method includes treating at least one surface of a pest infested building or structure by applying to the surface the aforementioned diluted pest control composition in an amount effective to kill and/or repel the pest, wherein the pest is selected from the group consisting of spiders, insects, fungi, and combinations thereof.

In one preferred embodiment, the pest includes spiders, and the spiders are killed and/or repelled and spiderweb formation is thereby reduced on the treated surface.

In another preferred embodiment, the pest includes insects. In still another preferred embodiment, the pest includes fungi, such as mold.

### DETAILED DESCRIPTION

The present disclosure provides a pest control composition. The composition is provided in both a concentrated form, and a diluted form.

The pest control composition generally includes at least one surfactant, and at least one essential oil. In some instances, the composition may further include at least one carboxylic acid and at least one alcohol. In diluted form, the composition also includes a solvent.

The pest control composition optionally includes one or more carboxylic acids, each of the acids having from 1 to 6 carbon atoms. Examples of suitable acids include, for example, formic acid, acetic acid, propionic acid, butyric acid, valeric acid, and caproic acid. A preferred acid is acetic acid.

In concentrated form, the composition preferably includes from about 2 to about 50 percent, by weight, of the at least one carboxylic acid. In diluted form, the composition preferably includes from about 1 to about 20 percent, by weight, of the at least one carboxylic acid. More preferably, the diluted composition may include from about 4 to about 6 percent, by weight, of the at least one carboxylic acid.

The composition also includes one or more surfactants. The surfactant is preferably anionic surfactant, although cationic surfactants, amphoteric surfactants, and non-ionic surfactants may also be used if desired. Suitable surfactants include, for example, quaternary ammonium compounds. A particularly preferred surfactant is sodium lauryl sulfate.

In concentrated form, the concentrated composition preferably includes from about 1 to about 50 percent, by weight, of the surfactant. In diluted form, the composition preferably includes from about 0.5 to about 10 percent, by weight, of the one or more surfactants. More preferably, the diluted composition may include from about 3.5 to about 5.5 percent, by weight, of the at least one surfactant.

In addition, the composition also includes one or more essential oils. The essential oils are preferably selected from the group consisting of thyme oil (chemotype linalool), lemon grass oil, citronella oil, lavender oil, phenethyl propionate, and combinations thereof.

In concentrated form, the concentrated composition preferably includes from about 1 to about 50 percent, by weight, of the one or more essential oils. In diluted form, the one or more essential oils preferably make up from about 0.5 to about 8 percent, by weight, of the composition. In a particularly preferred embodiment, the diluted composition includes a mixture of from about 1 to about 3 percent, by weight, thyme oil (chemotype linalool), about 1 to about 3 percent, by weight, lemongrass oil, and about 1 to about 3 percent, by weight, citronella oil.

The pest control composition may include an emulsifier for promoting mixture of the one or more essential oils in the pest control composition. An amount of emulsifier from about 1 percent to about 10 percent, by weight, may be included in the pest control composition. An example of a suitable emulsifier decyl alcohol containing 6 moles of potassium.

In certain embodiments, the pest control composition may also include from about 1 to about 20 percent, by weight, of at least one alcohol having from 1 to 6 carbon atoms. Examples of suitable alcohols include, for example, methyl alcohol, ethyl alcohol, propyl alcohols, butyl alcohols, amyl alcohols, and hexyl alcohols. A preferred alcohol is isopropyl alcohol.

In concentrated form, the concentrated composition preferably includes from about 5 to about 50 percent, by weight, of the alcohol. In diluted form, the composition preferably includes from about 1 to about 20 percent, by weight, of the at least one alcohol. More preferably, the diluted composition may include from about 5 to about 10 percent, by weight, of the at least one alcohol.

The composition may be diluted with a solvent. The solvent for the composition is preferably water, although other solvents such as alcohols, glycols or glycerol may also be used. A mixture of water and/or alcohol and/or carboxylic acid may also be used as the solvent. For instance, aqueous mixtures such as vinegar or wine may be used as the solvent.

The solvent typically makes up from about 80 to about 98 percent, by weight, of the final, diluted composition. The diluted composition may be prepared by combining from about 5 to about 50 percent, by weight, of the concentrate composition with from about 50 to about 95 percent, by weight, of the solvent.

In a particularly preferred embodiment, the diluted pest control composition may be made up of from about 70 to about 85 percent water; from about 4 to about 6 percent, acetic acid; from about 3.5 to about 5.5 percent sodium lauryl sulfate; from about 5 to about 10 percent isopropyl alcohol; and from about 1 to about 10 percent essential oils. All percentages are weight percentages. The essential oils most preferably include from about 1 to about 3 percent, by weight, thyme oil (chemotype linalool), about 1 to about 3 percent, by weight, lemongrass oil, and about 1 to about 3 percent, by weight, citronella oil, based on the overall composition.

In another preferred embodiment, the diluted pest control composition is made up of from about 50 to about 60 percent water; from about 5 to about 8 percent acetic acid; from about 10 to about 15 percent sodium lauryl sulfate; from about 5 to about 10 percent isopropyl alcohol; and from about 1 to about 8 percent essential oils. All percentages are weight percentages. The essential oils preferably include from about 1 to about 2 percent, by weight, of thyme oil, from about 1 to about 2 percent, by weight, lemongrass oil, and from about 1 to about 2 percent, by weight, citronella oil. The diluted pest control composition may also include from about 1 to about 2 percent, by weight, of linalool.

The presently disclosed composition may be used to control a variety of household pets. For example, the composition may be effectively used to kill and/or repel spiders, insects, fungi, and combinations thereof.

According to the present disclosure, the diluted pest control composition is applied to at least one surface of a pest infested building or structure in an amount effective to kill and/or repel the pest.

In one preferred embodiment, the pest includes spiders, and the spiders are killed and/or repelled and spiderweb formation is thereby reduced on the treated surface. In regard to spiders, the composition may also be applied as a cleaning composition to facilitate the removal of existing cobwebs.

In another preferred embodiment, the pest includes insects. For instance, the composition can be applied to plant foliage to kill mosquitoes resting during the day and to continue to repel them after the fact.

In still another preferred embodiment, the pest includes fungi, such as mold. For instance, the composition may be applied to plants (including both agricultural crops and ornamental crops) to eradicate and/or repel mold growth on the plant foliage.

The following nonlimiting example illustrates various additional aspects of the invention. Unless otherwise indicated, temperatures are in degrees Celsius and percentages are by weight based on the overall weight of the composition.

### EXAMPLE 1

### Effectiveness Against Insects

In this Example, a pest control composition in accordance was prepared having the following composition:
2% citronella
2% lemon grass oil
2% thyme oil
70% distilled white vinegar (5 wt. % acetic acid)
15% of a 30% aqueous solution of sodium lauryl sulfate
9% of a 99% solution of isopropyl alcohol

The effectiveness of the composition in killing and/or repelling insects was then tested, using crickets as a test species.

A total of six laboratory-testing stations were used. Each testing station was made up of an approximately 24 inch by 16-inch enclosure. Ten crickets were initially placed in each enclosure. Testing stations 1 and 2 were used as controls and included only the crickets without any application of the pest control composition. In testing stations 3 and 4, the pest control composition was applied to filter discs, with an application rate of approximately 0.2 grams per filter disc. Three treated filters were then placed in each of testing station 3 and 4, along with the crickets. Finally, in testing stations 5 and 6, the pest control composition was sprayed directly onto the crickets.

Each testing station was observed at time intervals of: (1) 30 minutes after introduction of the pest control composition; (2) 4 hours after introduction of the pest control composition; (3) 6 hours after introduction of the pest control composition; and (4) 24 hours after introduction of the pest control composition.

After 30 minutes, all of the crickets in testing stations 1 & 2 (the controls) were observed to be alive and moving freely within the enclosure. After the same time interval, all the crickets in testing stations 3 & 4 were also observed to be alive; however, the crickets were observed to be avoiding the treated filter discs, thus demonstrating the insect repellency of the composition. After 30 minutes, the crickets in both testing stations 5 & 6 (10 crickets each) were all observed to be dead. This demonstrates that the composition is effective in rapidly killing insects upon contact.

After four hours, all of the crickets in testing stations 1 & 2 (the controls) were again observed to be alive and moving freely within the enclosure. After the same four-hour time interval, all the crickets in testing stations 3 & 4 were also observed to still be alive. Two of the ten crickets both stations 3 &4 were observed to have crossed over the previously treated filter papers; however, the remaining crickets in stations 3 & 4 were still observed to be avoiding the treated filter discs, thus demonstrating the continuing insect repellency of the composition.

After six hours, all of the crickets in testing stations 1 & 2 (the controls) were again observed to be alive and moving freely within the enclosure. After the same six hour time interval, three of the ten crickets in stations 3 & 4 were observe to be dead, thus further demonstrating the effectiveness of the composition in killing insects. The remaining crickets were observed to be freely crossing the treated filter discs, however, indicating that the repellency of the composition had subsided.

The final observations, taken after twenty-four hours, were identical to the observations after six hours.

### EXAMPLE 2

### Effectiveness Against Mold

In this example, the effectiveness of the formulation in preventing the growth of fungi/mold on wood was tested. Two kiln dried clean rubberwood (Hevea braziliensis) samples measuring 13 inches by 2¼ inches by 1⅛ inches were momentarily dipped to half their length in a treatment composition. The first rubberwood sample was dipped in the same pest control composition disclosed in Example 1. The second rubberwood sample was dipped in a commercial moldicidal formulation based on a mixture of borate, IPBC (3-iodo-2-propynyl butylcarbamate) and propiconazole. The untreated halves of the samples acted as controls. Rubberwood was used as it contains a very high sugar content and is very susceptible to mold and fungal growth.

Unsterile samples were then placed in a humidity chamber at about 90% relative humidity and about 28 degrees C. for incubation under conditions conducive for mold growth, and were reliant on any natural inoculum for mold development. This is considered an aggressive high hazard test. Samples were then monitored at intervals of 1 week, 2 weeks, 1 month and 2 months.

Within 1 week non-colored surface fungal mycelium was evident on both untreated halves of the rubberwood samples, but both treated halves remained clean. At 2 weeks and at one month, both untreated halves had very extensive mold colonization covering the entire surfaces and showing both mycelium and colored areas of sporulation. Fungi from their conidiophores and conidial spores were tentatively identified as Trichoderma sp. Aspergillus sp. and Penicillium sp. amongst others not identified. Both treated halves still remained clean and free of visual fungal development.

At two months the untreated halves remained completely colonized but both the treated surfaced remained essentially free of colonization apart from a very few small mycelial growths. It was concluded that the formulation example of the invention performed at least as well as a very successful and fully commercialized mold preventive formulation.

### EXAMPLE 3

### Effectiveness as a Cobweb Cleaner & Repellant

In this example, the effectiveness of the pest control composition in cleaning/removing cobwebs was tested. Its effectiveness in repelling spiders and preventing the reoccurrence of new cobwebs was also tested. The pest control composition used in this example was the same as that disclosed in Example 1.

The pest control composition was tested on heavily cobweb infested boat docks at a lakeside marina near Knoxville, Tn. The composition was sprayed on the cobweb-infested surfaces of the galvanized steel and wood framing of the boat docks and roof supports at an application rate of about 1 gallon of the composition per 150-250 square feet of treated surface area. After application of the composition, a “Webster” cleaning brush was used to remove cobwebs from the treated surfaces. Removal of the cobwebs from the treated surfaces was observed to be noticeably easier than from untreated surfaces. Specifically, the webs appeared to melt slightly and lose their adhesion to the original surface and then adhere to the cleaning brush being used to remove them.

Following application of the composition, and removal of existing cobwebs, the treated surfaces were periodically observed to see if new cobwebs developed. The treated surfaces were observed to repel spiders, and thus prevent the development of new cobwebs, for a period of at least 30 days. In some cases, no new cobwebs were observed for up to 60 days.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

What is claimed is:

1. A pest control concentrate composition comprising:
from about 1 to about 50 percent, by weight, of at least one surfactant;
from about 1 to about 50 percent, by weight, of at least one essential oil;
optionally, from about 2 to about 50 percent, by weight, of at least one carboxylic acid having from 1 to 6 carbon atoms; and
optionally, from about 5 to about 50 percent, by weight, of at least one alcohol having from 1 to 6 carbon atoms, wherein all percentages are based on the concentrate in undiluted form.

2. The composition of claim 1, wherein the at least one carboxylic acid comprises acetic acid.

3. The pest control concentrate composition of claim 1, wherein the at least one surfactant comprises an anionic surfactant.

4. The pest control concentrate composition of claim 1, wherein the at least one surfactant comprises sodium lauryl sulfate.

5. The pest control concentrate composition of claim 1, wherein the at least one alcohol comprises isopropyl alcohol.

6. The composition of claim 1, wherein the at least one essential oil comprises an oil selected from the group consisting of thyme oil (chemotype linalool), lemon grass oil, citronella oil, lavender oil, phenethyl propionate, and combinations thereof.

7. A diluted pest control composition comprising:
from about 5 to about 50 percent, by weight, of the concentrate composition of claim 1; and
from about 50 to about 95 percent, by weight, of a solvent.

8. The diluted pest control composition of claim 7, comprising:
a solvent;
from about 1 to about 20 percent, by weight, of at least one carboxylic acid having from 1 to 6 carbon atoms
from about 0.5 to about 12 percent, by weight, of at least one surfactant;
from about 0.5 to about 8 percent, by weight, of at least one essential oil; and
optionally, from about 2 to about 20 percent, by weight, of at least one alcohol having from 1 to 6 carbon atoms, wherein all percentages are based on the composition in diluted form.

9. The diluted pest control composition of claim 7, comprising:
from about 70 to about 85 percent, by weight, water;
from about 4 to about 6 percent, by weight, acetic acid;
from about 3.5 to about 5.5 percent, by weight, sodium lauryl sulfate;
from about 5 to about 10 percent, by weight, isopropyl alcohol; and
from about 1 to about 10 percent, by weight, essential oils, wherein all percentages are based on the composition in diluted form.

10. The diluted pest control composition of claim 9, wherein the essential oils comprise from about 1 to about 3 percent, by weight, thyme oil (chemotype linalool), about 1 to about 3 percent, by weight, lemongrass oil, and about 1 to about 3 percent, by weight, citronella oil, wherein all percentages are based on the composition in diluted form.

11. The diluted pest control composition of claim 7, comprising:
from about 50 to about 60 percent, by weight, water;
from about 6 to about 8 percent, by weight, acetic acid;
from about 10 to about 15 percent, by weight, sodium lauryl sulfate;
from about 5 to about 10 percent, by weight, isopropyl alcohol; and
from about 1 to about 10 percent, by weight, essential oils, wherein all percentages are based on the composition in diluted form.

12. The diluted pest control composition of claim 11, wherein the essential oils comprise from about 1 to about 3 percent, by weight, thyme oil, from about 1 to about 3 percent, by weight, lemongrass oil, and from about 1 to about 3 percent, by weight, citronella oil.

13. The diluted pest control composition of claim 12, further comprising from about 1 to about 3 percent, by weight, linalool.

14. The diluted pest control composition of claim 13, further comprising from about 1 to about 7 percent, by weight, of an emulsifier.

15. The diluted pest control composition of claim 14 wherein the emulsifier comprises decyl alcohol.

16. A method for controlling household pests comprising:
treating at least one surface of a pest infested building or structure by applying to the surface the diluted pest control composition of claim 7 in an amount effective to kill and/or repel the pest,
wherein the pest is selected from the group consisting of spiders, insects, fungi, and combinations thereof.

17. The method of claim 16, wherein the pest includes spiders, and wherein the spiders are killed and/or repelled and spiderweb formation is thereby reduced on the treated surface.

18. The method of claim 16, wherein the pest includes insects.

19. The method of claim 16, wherein the pest includes fungi.
